(19) United States
(12) Patent Application Publication
(10) Pub. No.: US 2014/0029770 A1
(43) Pub. Date: Jan. 30, 2014

(54) HYBRID ANALOG/DIGITAL HEADSET

(71) Applicant: Conexant Systems, Inc., Irvine, CA (US)

(72) Inventors: Jonathan Chien, Tustin, CA (US); James Bunde Villadsen Skov, Laguna Niguel, CA (US); Andrew B. Webster, Irvine, CA (US); Lorenzo Crespi, Costa Mesa, CA (US); Eitan David, Irvine, CA (US); Sverrir Olafsson, Newport Beach, CA (US); Ludgero Leonardo, Stoughton, MA (US); Christian Larsen, Irvine, CA (US)

(73) Assignee: Conexant Systems, Inc., Irvine, CA (US)

(21) Appl. No.: 13/950,242

(22) Filed: Jul. 24, 2013

Related U.S. Application Data
(60) Provisional application No. 61/675,487, filed on Jul. 25, 2012.

(51) Int. Cl. H04R 3/00

(52) U.S. Cl. CPC H04R 3/00
USPC 381/123

(57) ABSTRACT

A device comprising a detector configured to receive an indication from a terminal of a connector and to determine whether the indication matches an expected result. One or more first switches are configured to connect one or more speaker transducers to the connector if the indication is false. One or more second switches are configured to connect the one or more speaker transducers to a digital output converter if the indication is true. The device can also include one or more third switches configured to connect one or more microphone elements to the connector if the indication is false, and one or more fourth switches configured to connect one or more microphones to a digital input converter if the indication is true. The input and output converters can be stand alone or part of a digital signal processor.

### RELATED APPLICATIONS

The present application claims benefit of U.S. Provisional Patent Application No. 61/675,487, filed Jul. 25, 2012, which is hereby incorporated by reference for all purposes as if set forth herein in its entirety.

### TECHNICAL FIELD

The present disclosure relates generally to headsets, and more specifically to a hybrid analog/digital headset that detects whether an analog or digital format signal is to be processed and which reconfigures itself to process the detected signal format.

### BACKGROUND OF THE INVENTION

Analog and digital headsets for audio systems are typically used with different types of connectors. For analog audio systems, the headsets typically use a tip/ring/sleeve (TRS) or tip/ring/sleeve/switch (TRSS) connector, whereas for digital audio systems, the headsets typically use a universal serial bus (USB) connector.

### SUMMARY OF THE INVENTION

A device, such as a set of headphones, that includes a detector that is configured to receive an indication from a connector and to determine whether the indication is present. One or more switches connect one or more speaker transducers to the connector if the indication is not present. One or more switches connect the one or more speaker transducers to a processor if the indication is present, such as for processing digital signals. One embodiment is comparing the voltage from the sleeve terminal of a connector and determining whether the voltage exceeds a threshold, such as a threshold voltage that is higher than a voltage associated with an analog'system and lower than a voltage associated with a digital system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a hybrid analog/digital headset in accordance with an exemplary embodiment of the present disclosure; and

FIG. 2 is a diagram of an algorithm for configuring an analog/digital headset in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Headsets with combined audio and microphone capability are typically connected to a host system by a 4-terminal tip/ring/sleeve/switch (TRSS) plug, which carries analog signals from the host to the headphone transducer/speakers and from the microphone to the host. This type of headset typically operates as a passive device, and its performance is often limited by the quality of the headphone amplifier and microphone preamplifier located in the host. In addition, this type of headset only supports one microphone and two speakers.

In some cases, such as in noise-cancelling headsets, an active circuit is added to the headset in order to improve sound quality. However, such active circuits must be powered by a battery that is incorporated into the headset, which is costly, bulky, and inconvenient for the user.

Recently, active digital headsets have been introduced that communicate with the host via USB protocol or other proprietary digital interfaces. These headsets achieve the goal of higher signal quality without requiring a battery, as they are powered by the host through the USB power supply. However, they are not backwards-compatible with conventional analog hosts, and can only be paired with specially equipped host systems.

In accordance with the present disclosure, a hybrid analog/digital headset is provided that employs a conventional TRSS plug and which can process either analog or digital signals from the host system. If the headset is plugged into a host that supports digital signaling, it automatically configures itself as an active digital headset and can deliver high sound quality by performing a variety of signal processing functions. Communications with the host can use USB protocols or other suitable protocols.

If the headset is plugged into a conventional analog host, it automatically configures itself as a passive device and performs as a conventional passive analog headset.

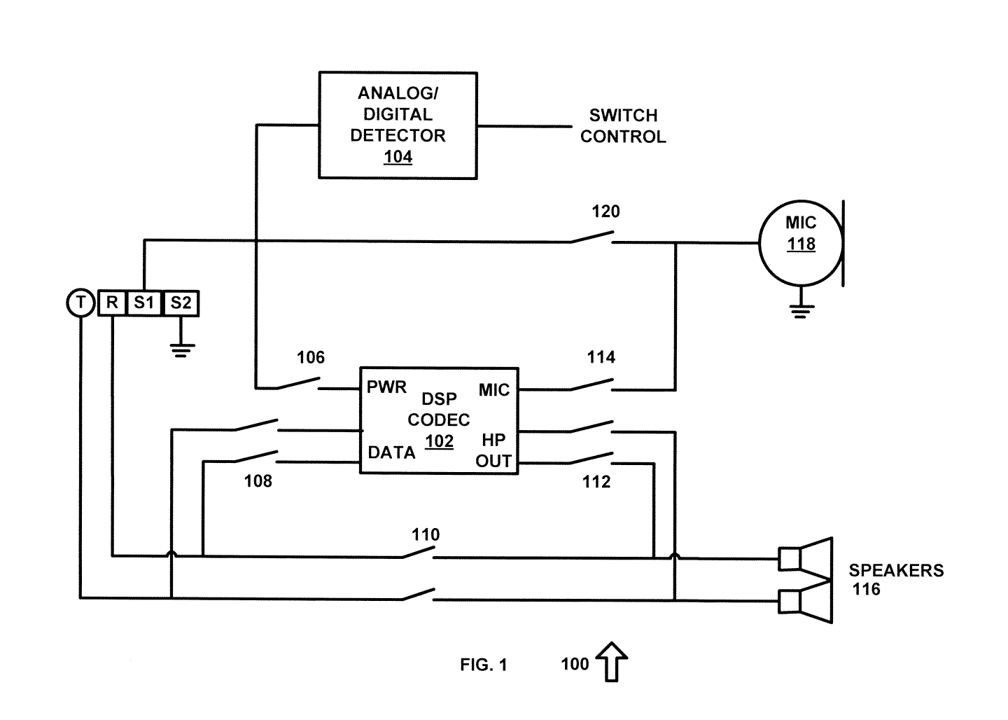

FIG. 1 is a diagram of a hybrid analog/digital headset 100 in accordance with an exemplary embodiment of the present disclosure. Analog/digital detector 104 senses the voltage on the sleeve terminal Si of the TRSS plug that is normally used for microphone biasing and signaling, and depending on the detected voltage, which is typically a DC voltage, analog/digital detector 104 determines whether the host is analog or digital. In one exemplary embodiment, when the host is analog, the sleeve terminal may be grounded (in the case of a 3-prong receptacle), connected to a microphone-bias reference voltage (which is typically lower than 3 V.), or may otherwise receive a voltage that is lower than a predetermined reference threshold voltage, such as 3.5 V. If the host is digital, the TRSS connector connects the sleeve terminal to a power supply with a voltage greater than the predetermined value, such as 4 V. This difference in the voltage that will be measured at the sleeve terminal allows the analog/digital detector to discriminate between analog and digital hosts, by comparing the sleeve voltage to the predetermined reference threshold voltage.

If analog/digital detector 104 determines that the detected voltage is lower than the predetermined reference threshold voltage, then it can be determined that the host is an analog system, and analog/digital detector 104 generates a control signal, such as one that closes switches 110 and 120 and opens the other switches, or other suitable signals or combinations of signals. In this mode, digital signal processor (DSP) codec 102 is isolated from all other components, and system 100 operates as a passive headset. Alternatively, switches 110 and 120 can be configured to be normally closed and the remaining switches can be configured to be normally open, such that analog/digital detector 104 does not need to generate a signal (e.g., the control signal can be a low or zero voltage signal). While a DSP codec 102 is shown that includes one or more algorithms having a structure that allows DSP codec 102 to perform the functions described herein, other circuits can also or alternatively be used, including one or more discrete logic components, audio signal processors or other suitable systems or circuits.

If analog/digital detector 104 determines that the detected voltage is higher than the predetermined reference threshold voltage, then it can be determined that the host is a digital system and analog/digital detector 104 generates a switch control signal that opens switches 110 and 120 and closes switches 106, 108, 112 and 114. In this mode, the direct connection between the host and speakers 116 is removed. In addition, the tip T and ring R terminals can be used as digital data lines between the host and DSP codec 102, and DSP codec 102 can manage the analog connections to speaker 116. In this mode, system 100 operates as an active digital headset. Switches 106 through 120 can be implemented using FET transistors, microelectrical mechanical systems (MEMS), or other suitable devices. In one exemplary embodiment, switch 110 is configured to be ON or closed while no power is present in the system. In the case of a FET implementation, this configuration can be achieved by employing depletion-type transistors in combination with an appropriate biasing network that is capable of turning the switch off or open when power is present.

The present disclosure provides the benefits of a digital USB headset, does not require any batteries, and is backwards compatible with a conventional host using analog 3- or 4-prong receptacles. As such, it can be used with digital, analog and mixed signal systems.

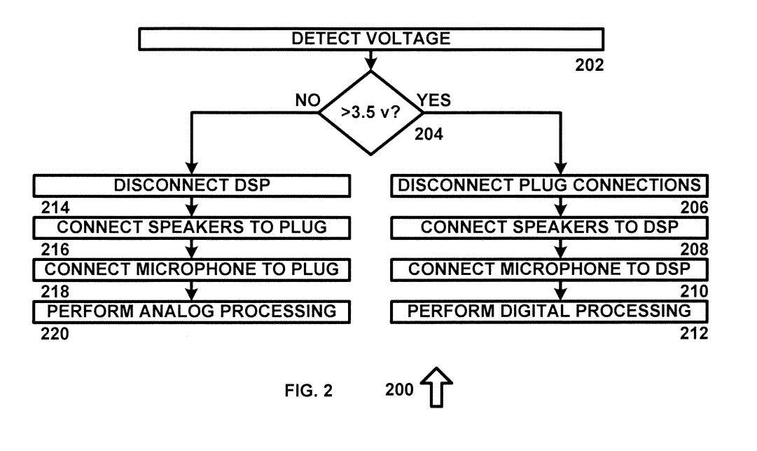

FIG. 2 is a diagram of an algorithm 200 for configuring an analog/digital headset in accordance with an exemplary embodiment of the present disclosure. Algorithm 200 can be implemented in hardware or a suitable combination of hardware and software, such as one or more software systems operating on a DSP.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Algorithm 200 begins at 202, where a voltage is detected, such as a voltage on a sleeve terminal of a TRSS connector. In one exemplary embodiment, the voltage can be applied to a circuit having a predetermined reference threshold voltage, such as a predetermined configuration of diodes, diode-connected transistors or other suitable devices that generate a low voltage output when the applied voltage is below the predetermined reference threshold voltage and that generate a high voltage output when the applied voltage is greater than the predetermined reference threshold voltage. Likewise, other suitable circuitry can also or alternatively be used. The algorithm then proceeds to 204.

At 204, it is determined whether the detected voltage is greater than a predetermined reference threshold voltage, such as 3.5 V. In one exemplary embodiment, the determination can be made using hardware, but other suitable configurations can be used, such as a software system operating on a DSP that generates a first output voltage if power to the DSP is not being received and a second output voltage if power to the DSP is being received. In one exemplary embodiment, a signal generated by a voltage detector can be used to control a switch that connects a DSP to a power source, or other suitable circuits or systems can also or alternatively be used. If it is determined that the detected voltage is greater than the predetermined reference threshold voltage, the algorithm proceeds to 206 where the microphone and speaker transducers are disconnected from a direct connection to the plug terminals. In one exemplary embodiment, a control signal can be generated for normally closed/on transistors or switches to cause them to change state to an open/off setting. The algorithm then proceeds to 208 where the speaker transducers are coupled to the DSP, such as by generating a control signal to cause a normally open/off transistor or switch to change state to a closed/on state. The algorithm then proceeds to 210, where the microphone is coupled to the DSP, such as by generating a control signal to cause a normally open/off transistor or switch to change state to a closed/on state. The algorithm then proceeds to 212, where digital processing of the speaker transducer and microphone signals is performed.

If it is determined at 204 that the detected voltage is less than the predetermined reference threshold voltage, the algorithm proceeds to 214, where connections between a DSP and a microphone and speaker transducers are changed, such as from a normally closed/on state to an open/off state. In one exemplary embodiment, the connections between the DSP and the microphone and speaker transducers are in a normally open/off state, such that no change in state is required at 214. The algorithm then proceeds to 216.

At 216, the speaker transducers are directly connected to the TRSS connector or other suitable connectors. In one exemplary embodiment, the connections between the TRSS connector or other suitable connectors and the speaker transducers are in a normally closed/on state, such that no change in state is required at 216. The algorithm then proceeds to 218.

At 218, the microphone is directly connected to the TRSS connector or other suitable connectors. In one exemplary embodiment, the connections between the TRSS connector or other suitable connectors and the microphone are in a normally closed/on state, such that no change in state is required at 218. The algorithm then proceeds to 220, where analog processing of the speaker transducer and microphone signals is performed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A device comprising:
a detector configured to receive an indication from a terminal of a connector and to generate a control signal if the indication is present;
one or more first switches configured to connect one or more speaker transducers to the connector if the indication is not present; and
one or more second switches configured to connect the one or more speaker transducers to a processor if the indication is present.

2. The device of claim 1 further comprising one or more third switches configured to connect the processor to the connector if the indication is present.

3. The device of claim 1 wherein the detector is configured to generate the control signal to cause the one or more first switches for connecting the one or more speaker transducers to the connector to change state.

4. The device of claim 1 wherein the detector is configured to generate the control signal to cause the one or more second switches for connecting the one or more speaker transducers to the processor to change state.

5. The device of claim 2 wherein the detector is configured to generate the control signal to cause the one or more third switches for connecting the processor to the connector to change state.

6. The device of claim 1 wherein the one or more first switches are normally closed.

7. The device of claim 1 wherein the one or more second switches are normally open.

8. The device of claim 2 wherein the one or more third switches are normally open.

9. The device of claim 1 further comprising:
one or more third switches configured to connect one or more microphones to the connector if the indication is not present; and
one or more fourth switches configured to connect the one or more microphones to the processor if the indication is present.

10. The device of claim 9 wherein the one or more third switches are normally closed.

11. The device of claim 9 wherein the one or more fourth switches are normally open.

12. The device of claim 9 further comprising one or more fifth switches configured to connect the processor to the connector if the indication is present.

13. A method for controlling a device comprising:
receiving an indication from a connector;
connecting one or more speaker transducers to the connector if the indication is false; and
connecting the one or more speaker transducers to a processor if the indication is true.

14. The method of claim 13 wherein connecting the one or more speaker transducers to the connector if the indication is false comprises allowing one or more normally closed switches to remain closed.

15. The method of claim 13 wherein connecting the one or more speaker transducers to the processor if the indication is true comprises causing one or more normally open switches to close.

16. The method of claim 13 further comprising connecting one or more microphones to the connector if the indication is false.

17. The method of claim 13 further comprising connecting the one or more microphones to the processor if the indication is true.

18. The method of claim 13 wherein connecting the one or more speaker transducers to the processor if the indication is true comprises generating a control signal to cause one or more normally open switches to close.

19. The method of claim 16 wherein connecting one or more of the microphones to the connector if the indication is false comprises generating a switch control signal to change a state of one or more switches.

20. A device comprising:
a detector configured to receive an indication from a terminal of a connector and to generate a control signal if the indication is present;
one or more first switches configured to connect one or more speaker transducers to the connector if the indication is not present;
one or more second switches configured to connect the one or more speaker transducers to a processor if the indication is present;
one or more third switches configured to connect the processor to the connector if the indication is present;
one or more fourth switches configured to connect one or more microphones to the connector if the indication is not present;
one or more fifth switches configured to connect the one or more microphones to the processor if the indication is present;
one or more sixth switches configured to connect the processor to the connector if the indication is present; and
wherein the detector is configured to generate the control signal to cause the one or more first switches for connecting the one or more speaker transducers to the connector to change state, the detector is configured to generate the control signal to cause the one or more second switches for connecting the one or more speaker transducers to the processor to change state, the detector is configured to generate the control signal to cause the one or more third switches for connecting the processor to the connector to change state, the one or more first switches are normally closed, the one or more second switches are normally open, the one or more third switches are normally open, the one or more fourth switches are normally closed, the one or more fifth switches are normally open and the one or more sixth switches are normally open.
